(19) United States
(12) Patent Application Publication
(10) Pub. No.: US 2026/0147339 A1
(43) Pub. Date: May 28, 2026

(54) LOCATING A REFERENCE STATION SETUP POINT

(71) Applicant: Wirtgen GmbH, Windhagen (DE)

(72) Inventors: René Müller, Vettelschoß (DE); Ruud DeJong, Olney, IL (US)

(21) Appl. No.: 19/379,824

(22) Filed: Nov. 5, 2025

(30) Foreign Application Priority Data
Nov. 7, 2024 (DE) 10 2024 132 433.3

(51) Int. Cl. G05D 1/224; E02F 9/20; G05D 1/248; G05D 105/05; G05D 107/70; G05D 109/10; G05D 111/30; G06F 16/955; G06K 7/14

(52) U.S. Cl. CPC G05D 1/2244; E02F 9/205; G05D 1/248; G06F 16/9554; G06K 7/1417; G05D 2105/05; G05D 2107/70; G05D 2109/10; G05D 2111/34

(57) ABSTRACT

A self-propelled construction machine includes a DGNSS rover unit including a computing and evaluation unit, configured such that, on the basis of satellite signals and correction signals of a reference station, construction machine position data describing the position of a construction machine reference point are determined. The computing and evaluation unit generates at least one machine-readable data set, in particular a QR code, which is shown on a display for a reference station position data set stored in a reference station position data memory device. The QR code can be scanned with a smartphone on which a map service with a navigation function is installed, so that the setup point on which a reference station is to be set up can be easily found on the site. In an alternative embodiment, the data can also be scanned using an NFC receiving unit (NFC reader) based upon RFID technology.

### BACKGROUND OF THE DISCLOSURE

The disclosure relates to a self-propelled construction machine with a machine frame, supported by running gears, and a working device for working the ground or erecting structures on a site, wherein the self-propelled construction machine comprises a DGNSS rover unit for receiving satellite signals from a global navigation satellite system and correction signals from a reference station to be set up in the vicinity of the self-propelled construction machine, and the DGNSS rover unit has a computing and evaluation unit, which is configured such that, on the basis of the satellite signals and the correction signals from the reference station, construction machine position data describing the position of a construction machine reference point on the construction machine are determined in a coordinate system independent of the construction machine. Furthermore, the disclosure relates to an arrangement comprising a self-propelled construction machine with a machine frame, supported by running gears, and a working device for working the soil or erecting structures on a site, and a mobile terminal. Furthermore, the disclosure relates to a method for locating a reference station setup point of a reference station to be set up in the vicinity of a self-propelled construction machine.

### DESCRIPTION OF THE PRIOR ART

Self-propelled construction machines are understood to be all construction machines that have a working device arranged on a machine frame for erecting structures on a site or for altering the site. Well-known self-propelled construction machines include, for example, road milling machines, stabilizers, recyclers, slipform pavers, and road pavers. In road milling machines or recyclers, the working device comprises a milling/cutting drum equipped with milling or cutting tools, by means of which material can be removed from the site within a specified working width. The working device of slipform pavers is a device for forming flowable material, in particular concrete, with which structures of different designs, e.g., guide walls or traffic islands, can be produced. The known road pavers comprise a paving screed for laying the material for the road surface. Soil compactors such as road rollers have at least one compaction device for compacting the subsoil.

During the construction of structures on the ground surface or during the alteration of the site, high demands are placed upon the precision of the construction work. In the control of self-propelled construction machines, the aim is therefore increasingly to relieve the machine operator, who is burdened with a multitude of tasks during construction work. Accordingly, known self-propelled construction machines use position determination systems that determine the position of a reference point on the self-propelled construction machine in a coordinate system independent of the construction machine.

The term GPS (Global Positioning System) is used to describe a position determination system that is based upon the evaluation of the signal propagation times of signals from several satellites. The abbreviation GPS is used today colloquially, and sometimes even in technical language, as a generic term or pars pro toto for all satellite navigation systems, which are correctly subsumed under the abbreviation GNSS (Global Navigation(al) Satellite System) (Wikipedia: GPS). The term DGPS (Differential Global Positioning System) or DGNSS is used to describe a method that increases the accuracy of GNSS position determination by emitting correction signals (orbit and time system). DGNSS can also use stationary reference stations, known as base stations, which can be used to determine the actual propagation times of the signals for each satellite very precisely from the deviation between the actual and the received positions. The differences between the theoretical and actual signal propagation times are transmitted to the DGNSS receivers, which correct their position using these correction signals (Wikipedia: DGPS). In the following, a GPS rover unit or GNSS rover unit is also understood to mean a DGPS or DGNSS rover unit or vice versa, wherein the terms (D)GPS and (D)GNSS are used synonymously in this context.

DE 197 56 676 C1 (U.S. Pat. No. 6,371,566) describes a road milling machine that has a DGNSS for position determination. The construction machine has a DGNSS rover unit for receiving satellite signals of a global navigation satellite system and correction signals of a reference station, wherein the DGNSS rover unit is configured such that, on the basis of the satellite signals and the correction signals, position data describing the position of a reference point on the construction machine are determined in a coordinate system independent of the construction machine. For determining the correction signals, the reference station must know its own position.

FROM DE 10 2022 124 484 A1 (US 2024/103179), A POSITION DETERMINATION

system for determining the position of a reference point on a self-propelled construction machine is known, which system has a DGNSS rover unit for receiving satellite signals of a global navigation satellite system and correction signals of a reference station. The reference station is configured such that it can determine its own reference station position. However, since the reference station position determined by the reference station itself is inaccurate, the actual reference station position is communicated to the reference station through an initialization.

DE 10 2022 124 484 A1 (US 2024/103179) proposes, in order to initialize the reference station, reading out a position data set describing the specified positions of a reference station from a memory unit and determining the actual reference station position on the basis of a comparison of the specified positions of the reference station with the reference station position determined by the reference station. The comparison allows for automated assignment of the relevant coordinate values, so that the coordinate values of the actual position of the reference station can be selected from the position data set without requiring additional input on the construction site. This simplifies initialization and eliminates incorrect input.

The reference station for transmitting the correction signals to the DGNSS rover unit is set up in the vicinity of the self-propelled construction machine in order to increase the accuracy of position determination. When the construction machine moves across the site, the reference station must be relocated, since the range for a radio connection between the DGNSS rover unit and the reference station is limited, and the accuracy of the position determination decreases as the distance between the rover unit and the reference station increases.

In practice, a reference station is set up on the site at a certain reference station setup point, which has been previously defined during the planning of the construction site and whose position data are known. During site planning, a plurality of reference station setup points are generally defined, which are located in the vicinity of the path along which the self-propelled construction machine is to move. A surveyor determines the position of the reference station setup point on the site using a conventional surveying method and marks the reference station setup point with a marking element, so that the reference station setup point can be found again later.

Before the actual construction work begins, a reference station is generally set up at the first reference station setup point, and is then relocated. However, if a plurality of reference stations are available, reference stations can also be set up at a plurality of reference setup points.

Although the reference station setup points have been previously marked on the site by the surveyor, in practice, locating the reference station setup points may prove difficult if the marking elements are difficult to recognize. The marking elements may be obscured by structures, trees, or bushes. Locating the marking elements becomes increasingly difficult as the distance between the reference station setup points and the self-propelled construction machine increases.

### SUMMARY OF THE DISCLOSURE

The disclosure is based upon the object of creating a self-propelled construction machine having a machine frame, supported by running gears, and a working device for working the soil or erecting structures on a site and an arrangement comprising such a self-propelled construction machine and a mobile terminal, which facilitates locating the marked reference station setup points. Furthermore, it is an object of the disclosure to provide a method that facilitates locating a reference station setup point of a reference station to be set up in the vicinity of a self-propelled construction machine.

These objects are achieved according to the disclosure with the features of the independent claims. The subject matter of the dependent claims relates to preferred embodiments of the disclosure.

In the following, a reference station setup point is understood to be a certain spatial location on the site at which a reference station is or is to be set up in the vicinity of a self-propelled construction machine that is moving or is to move along a specified path on the site. A specified path does not mean that the construction machine must drive autonomously. The construction machine can also be controlled by the machine operator. The position of a reference station setup point on the surface of the site is described by reference station position data. The position data can be geographical coordinates that can be used to describe the location of a point on the Earth's surface. A reference station position data set comprises the position data of a plurality of, i.e., at least two, reference station setup points.

The embodiments of the disclosure described below can comprise one or more of the features or combinations of features mentioned below. A feature designated with an indefinite article can also be present more than once if the indefinite article is not to be understood as an explicit reference to a single use. A designation of features with a number word, e.g., “first and second,” does not preclude the number of these features being greater than the number indicated by the number word. In the description of all the embodiments, the expression “can” is also to be understood as “preferably” or “expediently.”

The self-propelled construction machine according to the disclosure has a DGNSS rover unit for receiving satellite signals from a global navigation satellite system and correction signals from a reference station to be set up in the vicinity of the self-propelled construction machine, wherein the DGNSS rover unit has a computing and evaluation unit that is configured such that, on the basis of the satellite signals and the correction signals from the reference station, construction machine position data describing the position of a construction machine reference point on the construction machine are determined in a coordinate system independent of the construction machine.

A DGNSS rover unit is understood to mean a unit of the self-propelled construction machine that can determine the position of the construction machine. The DGNSS rover unit can have a GPS antenna, which can be arranged at the construction machine reference point, so that the GPS antenna can receive the satellite signals. The DGNSS rover unit can also comprise two GPS antennas to determine not only the position of the construction machine, but also its orientation on the site. The DGNSS rover unit can at least partially comprise one or more components or assemblies of the self-propelled construction machine. For example, at least part of the computing and evaluation unit of the DGNSS rover unit can be part of a central computing and evaluation unit of the self-propelled construction machine. The DGNSS rover unit can also form an independent unit.

The computing and evaluation unit of the DGNSS rover unit can have, for example, a general processor, a digital signal processor (DSP) for continuously processing digital signals, a microprocessor, an application-specific integrated circuit (ASIC), a field-programmable gate array (FPGA), or other integrated circuits (IC) or hardware components. A data processing program (software) can run on the hardware components. A combination of the various components is also possible.

The computing and evaluation unit of the DGNSS rover unit has a reference station position data memory device for storing a reference station position data set containing reference station position data, wherein the reference station position data in each case describe the reference station setup point of a reference station of a plurality of reference stations to be set up in the vicinity of a path on which the self-propelled construction machine moves. In this connection, a reference station position data memory device is understood to mean all data memory devices with which a reference station position data set can be stored at least briefly in order to be available for further data processing with the computing and evaluation unit.

The reference station position data can also be data that are determined and stored only during the execution of the construction work, e.g., if a new reference station setup point is subsequently defined, because a reference station setup point specified during planning should prove to be unsuitable-for example, due to shading.

The reference station position data memory device can be assigned an interface for importing reference station position data from an external data source. The interface can, for example, be a USB interface, wherein the data source can be a USB stick. The reference station position data can also be transmitted via a cellular network, WLAN, or Bluetooth. For example, the reference station position data set can be provided on an external server (cloud). The reference station position data set can also be sent by e-mail, for example.

The computing and evaluation unit of the DGNSS rover unit is configured such that one machine-readable data set is generated for the reference station position data set stored in the reference station position data memory device, or a plurality of machine-readable data sets are generated.

A machine-readable data set is understood to mean a data set that is intended and suitable for transmitting a reference station position data set to a device separate from the construction machine and is available to the device (machine) in an automatically readable form.

The basic principle of the disclosure is to provide the operating personnel entrusted with setting up the reference station or reference stations with information about the position of the reference station reference point in a simple, safe, and fast manner, which can be scanned using a mobile terminal that is not part of the self-propelled construction machine. The mobile terminal then allows the processing of this information regardless of the location of the construction machine, whereby locating the reference station reference point on the site is facilitated. Mobile terminals can be mobile phones, in particular smart mobile phones (smartphones), laptops, tablets, or the like. Mobile terminals can also be NFC (near-field communication) readers, which are based upon RFID (radio-frequency identification) technology. Short-range wireless connection protocols, such as Bluetooth, can also be used for signal transmission.

In one embodiment of the self-propelled construction machine according to the disclosure, the machine-readable data set is a machine-readable code, in particular a QR code, and a display is assigned to the DGNSS rover unit, wherein the DGNSS rover unit is configured such that the one machine-readable code is shown on the display, or at least one of the plurality of machine-readable codes is shown on the display.

A QR code is established as a public standard (Wikipedia). The QR code consists of a square matrix of black and white squares or dots that represent the encoded position data in binary form.

A display is understood to mean any device used to visualize information. On the display, only a single QR code can be shown, which encodes the reference station position data that describe the position of a single reference station. The QR codes of a plurality of reference stations can be shown one after the other on a single display. However, on a single display, a plurality of QR codes can also be shown simultaneously, with which the reference station position data of a plurality of reference stations are encoded, which describe the positions of a plurality of reference stations. There can also be a plurality of displays on which QR codes are shown. The display can be located in the region of the operator station and/or at another location on the construction machine that is easily accessible to the operating personnel.

One embodiment of the self-propelled construction machine according to the disclosure provides that the computing and evaluation unit of the DGNSS rover unit be configured such that, for all reference station position data of the reference station position data set stored in the reference station position data memory device, in each case a machine-readable code containing the reference station position data of the respective reference station is generated, and that the computing and evaluation unit be configured such that the machine-readable codes of all reference station position data are shown on the display.

In a preferred embodiment, the computing and evaluation unit is configured such that a QR code is generated which contains a URL (Uniform Resource Locator) of a website. Consequently, all services available on the Internet can be used to locate the reference station location by accessing a website by entering the URL into a browser or by starting an application (app). Suitable websites and apps are widely available.

The disclosure also relates to an arrangement comprising such a self-propelled construction machine, which has a machine frame, supported by running gears, and a working device for working the soil or erecting structures on a site, and a mobile terminal. The mobile terminal is characterized by the availability of an online map service on the terminal, which allows easily locating the reference station setup point on a map. The online map service can be provided by an application installed on the mobile terminal, which is started automatically after the QR code is scanned. Such mobile terminals are part of the prior art and are generally available to the operating personnel in the form of a smartphone.

A preferred embodiment provides that an online map service with a navigation function be installed on the mobile terminal, which not only allows the operating personnel to easily, quickly, and safely locate the reference station setup point on a map, but also guides the operating personnel to the reference station setup point using the mobile terminal.

The method according to the disclosure for locating the position of a reference station setup point of a reference station to be set up in the vicinity of a self-propelled construction machine comprises the following method steps:
importing a reference station position data set from an external data source into a reference station position data memory device, wherein the reference station position data in each case describe the reference station setup point of a reference station of a plurality of reference stations to be set up in the vicinity of a path on which the self-propelled construction machine moves, and
creating one or more machine-readable data sets for the reference station position data set, stored in the reference station position data memory device, with the computing and evaluation unit.

The machine-readable data set can be a machine-readable code, in particular a QR code, wherein the method can further comprise the following method steps:
displaying the one machine-readable code or displaying at least one machine-readable code of the plurality of machine-readable codes on a display assigned to the DGNSS rover unit, andscanning the one machine-readable code or at least one machine-readable code of the plurality of machine-readable codes with a mobile terminal, in particular a smartphone.

For all reference station position data of the reference station position data set stored in the reference station position data memory device, in each case a QR code containing the reference station position data of the respective reference station can be generated. All reference station position data can be shown on the display.

A preferred embodiment of the method according to the disclosure provides that an online map service for locating the reference station setup point on the site, in particular an online map service with a navigation function, be installed on the mobile terminal, in particular a smartphone.

The machine-readable data set or at least one of the plurality of machine-readable data sets can also be sent to a mobile terminal using a transmitting unit, in particular an NFC transmitting unit based upon RFID technology.

### BRIEF DESCRIPTION OF THE DRAWINGS

Exemplary embodiments of the disclosure will be explained in more detail below with reference to the drawings.

In the drawings:

FIG. 1 is a side view of a self-propelled construction machine,

FIG. 2 is a plan view of the self-propelled construction machine of FIG. 1,

FIG. 3 shows the DGNNS rover unit of the self-propelled construction machine and the reference station in a simplified schematic representation,

FIG. 4 shows the self-propelled construction machine moving along a path, with the reference station set up at a first position,

FIG. 5 shows the self-propelled construction machine moving along a path, with the reference station set up at a second position,

FIG. 6 shows the self-propelled construction machine moving along a path, with the reference station set up at a third position,

FIG. 7 shows the self-propelled construction machine moving along a path, with the reference station set up at a fourth position,

FIG. 8 is a screen view of the display provided on the self-propelled construction machine showing the QR codes of the reference station setup points, and

FIG. 9 shows an alternative embodiment of the DGNNS rover unit of the self-propelled construction machine.

### DETAILED DESCRIPTION

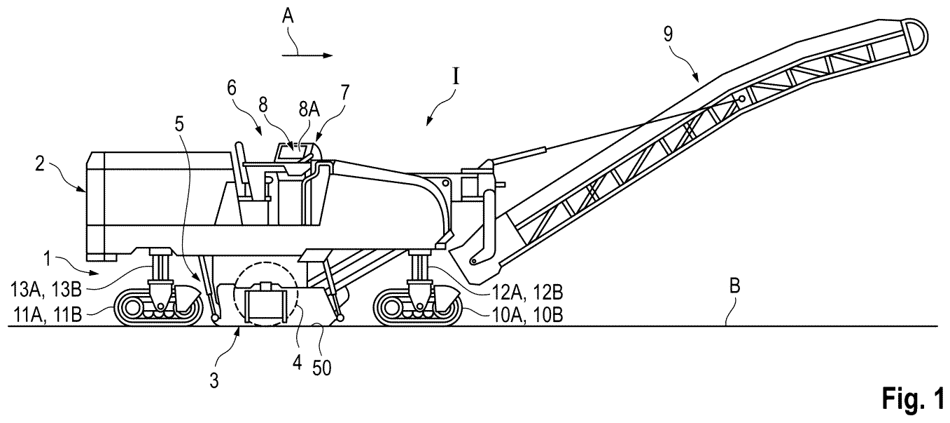

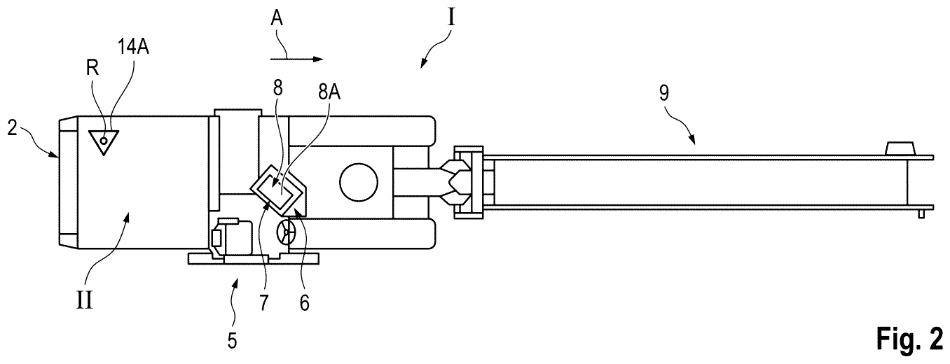

FIGS. 1 and 2 show, in side view and plan view, a road milling machine for milling road surfaces as an example of a self-propelled construction machine, the road milling machine being a front-loader road milling machine.

The construction machine I comprises a machine frame 2 carried by a chassis 1 and on which a working device 3 is arranged, by means of which the work required for the construction project can be carried out. The working device 3 may also be referred to as a working tool 3. The working device 3 has a milling drum 4, shown only schematically in FIG. 1, which is arranged in a milling drum housing 5. The milling drum housing 5 is closed on both sides by an edge guard 50. Above the milling drum housing 5, there is an operator station 6, arranged on the machine frame, with a control panel 7 for the machine operator. The control panel 7 comprises a display unit 8 with a display 8A, which can be designed as a touchscreen.

The self-propelled construction machine I can have, in the working direction A, a front left running gear 10A, a front right running gear 10B, a rear left running gear 11A, and a rear right running gear 11B, which are associated with, in the working direction A, a front left and right lifting device 12A, 12B and rear left and right lifting device 13A, 13B, respectively, so that, by retracting or extending the lifting devices, the height and inclination of the machine frame 2 relative to the ground surface B can be changed. Furthermore, the self-propelled construction machine I can have a transport device 9 for transporting away milled material. The running gears 10A, 10B, 11A, 11B are shown as tracks, but wheels may also be used. The running gears 10A, 10B, 11A, 11B may also be referred to as wheels or tracks 10A, 10B, 11A, 11B.

The construction machine I is controlled by a central control and computing unit, not shown in the figures, as a function of construction machine position data that describe the position of a reference point R on the construction machine in a coordinate system independent of the construction machine. For determining the position of a reference point R on the construction machine I, a position determination system II is provided, the structure and function of which are described in detail below.

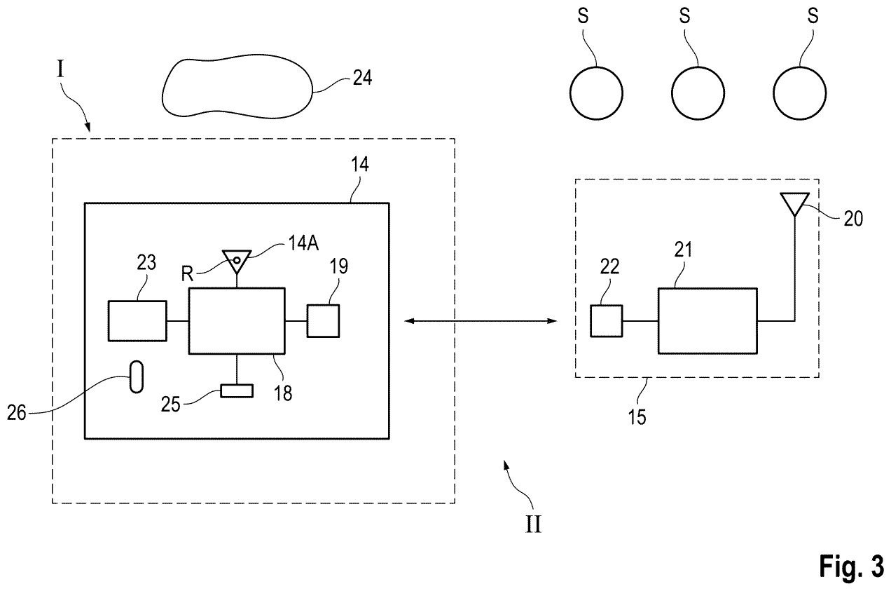

FIG. 3 shows a simplified schematic representation of the position determination system II, which comprises a GNSS rover unit 14 and a reference station 15. The GNSS rover unit 14 is provided on the construction machine I, which is only indicated by dotted lines, so that the GNSS rover unit 14 moves with the construction machine I across the site, while the reference station 15 is set up in the vicinity of the construction machine.

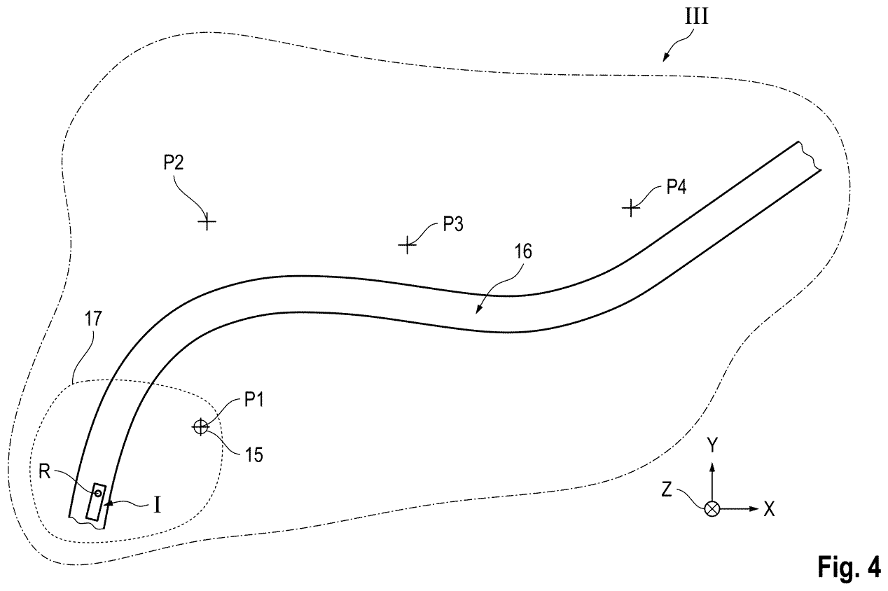

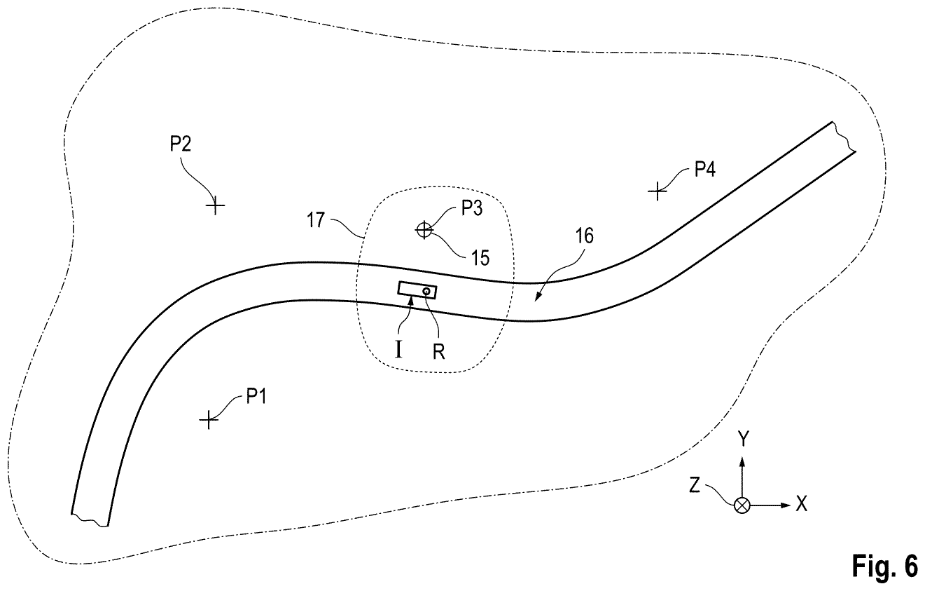

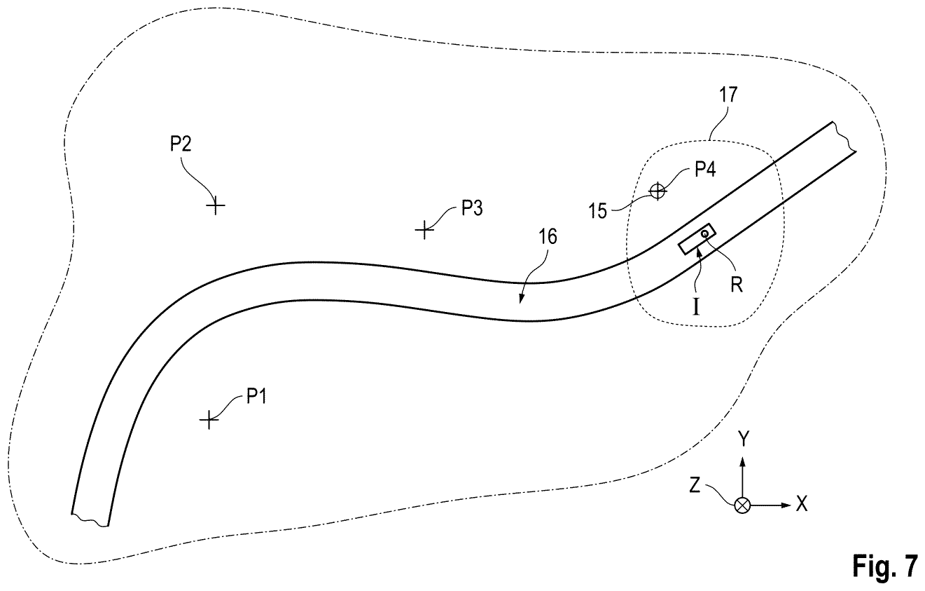

FIGS. 4 to 7 show the movement of the construction machine I, in particular a road milling machine, over the site along a specified path 16, in particular a road. The setup locations for the reference station along the specified path 16 are generally specified during planning of the construction site. In the following, these setup locations are also referred to as reference station setup points P1, P2, P3, and P4. The positions of the reference station setup points on the Earth's surface are described by geographical coordinates (spherical coordinates), which can be specified in various numerical formats. In the present exemplary embodiment, the positions of the reference station setup points on the site are described by latitude (φ) and longitude (Δ) in decimal form.

During the planning of the construction site, the reference station position data (latitude (φ) and longitude (Δ)) are determined for all reference stations to be set up along the path, and describe the position of the reference station setup point P1, P2, P3, or P4 of the respective reference station. These reference station position data are summarized in a reference station position data set, which is to be made available to a surveyor and to the control system of the construction machine. The data describing the location of each one of the reference station setup points may be referred to as a data sub-set of the reference station position data set.

Before the actual construction work begins, the positions of the reference station setup points P1, P2, P3, and P4 are determined on the site by a surveyor using a conventional surveying method, and the reference station setup points P1, P2, P3, and P4 are marked with a marking element, in order to be found again later for setting up the reference station. In FIGS. 4 to 7, the reference station setup points P1, P2, P3, and P4 for the reference station, at which the reference station 15 is to be set up, are marked with a cross.

As the construction machine I moves along the path 16, the reference station 15 is relocated several times, so that the reference station always remains in a vicinity 17 of the construction machine I, which does not exceed a certain radius.

The DGNSS rover unit 14 comprises at least one GPS antenna 14A, which is arranged at the reference point R of the construction machine I (FIG. 2), a computing and evaluation unit 18, and a bidirectional transmitting and receiving unit 19 (FIG. 3). The reference station 15 comprises a GPS antenna 20, a computing and evaluation unit 21, and a bidirectional transmitting and receiving unit 22. DGNSS rover unit 14 and reference station 15 communicate via the transmitting and receiving units 19, 22, which are intended to represent the known transmission links that can operate according to the known transmission methods (RF transmitter/receiver, WLAN, Bluetooth, etc.).

The GPS antenna 20 of the reference station 15 receives the satellite signals of a plurality of satellites of at least one satellite navigation system S, wherein the computing and evaluation unit 21 thereof is configured such that the position of the reference station 15 in a coordinate system independent of the construction machine is determined from the satellite signals with an accuracy corresponding to that of the GPS system. This position is referred to as the reference station position determined or measured by the reference station. The computing and evaluation unit 21 of the reference station 15 is further configured such that correction signals are calculated by known methods on the basis of the actual reference station position and the reference station position determined by the reference station, for which purpose the actual reference station position must be known, in addition to the measured reference station position. This corresponds to the known position of the specified reference station setup point.

The DGNSS rover unit 14 likewise receives the satellite signals from several satellites of a global navigation satellite system S via the GPS antenna 14A. In addition, the DGNSS rover unit 14 receives the correction signals from the reference station 15 via the transmitting and receiving unit 19. The computing and evaluation unit 18 of the GNSS rover unit 14 is configured such that, according to the known methods, on the basis of the satellite signals and the correction signals, the construction machine position data describing the (exact) position of the reference point R on the construction machine I are determined with a higher accuracy in the coordinate system (X, Y, Z) independent of the construction machine.

In addition, the DGNSS rover unit 14 has a reference station position data memory device 23 in which the reference station position data set containing the reference station position data is stored.

In the present exemplary embodiment, the reference station position data set created during planning is provided in an external data source 24, in particular an external server, and is scanned into the reference station position data memory device 23 via an interface 25 assigned to the reference station position data memory device 23. The reference station position data memory device 23 may also be referred to as a reference station position data memory 23.

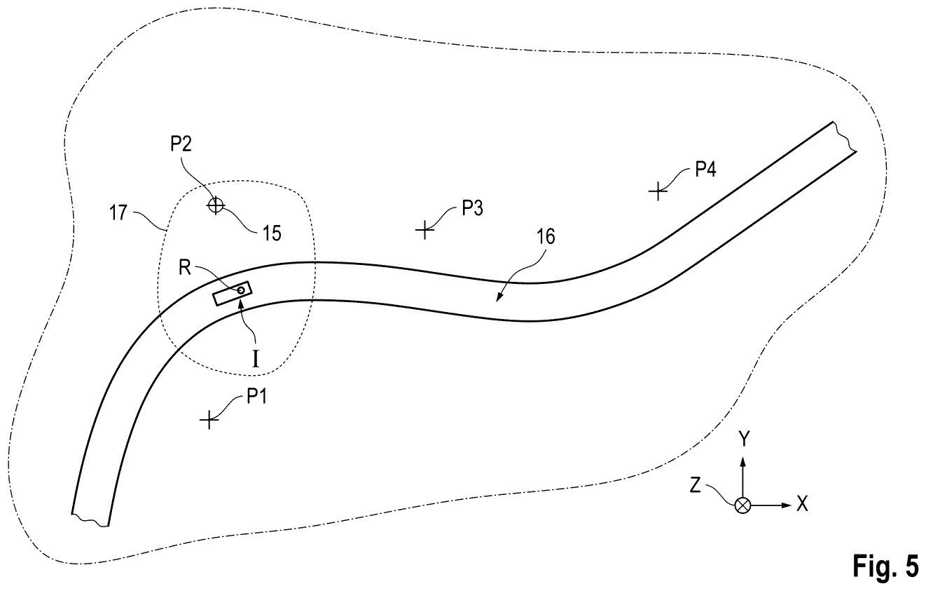

Before the actual construction work begins, a reference station 15 is set up at the first reference station setup point. For this purpose, the operating personnel must be able to locate the reference station setup point P1 previously marked on the site (FIG. 4). During the construction work, the reference station 15 will be relocated several times. For this purpose, the operating personnel must be able to locate the other reference station setup points P2, P3, and P4 (FIGS. 5 to 7).

In the present exemplary embodiment, the computing and evaluation unit 18 of the DGNSS rover unit 14 reads out the reference station position data set with the reference station position data of all reference station setup points P1, P2, P3, and P4 (latitude (φ) and longitude (Δ)) from the reference station position data memory device 23. The computing and evaluation unit 18 of the DGNSS rover unit 14 is configured such that, for all reference station position data, a QR code is created, which contains the respective reference station position data. In the present exemplary embodiment, the DGNSS rover unit 14 is assigned the display 8A of the display unit 8 on the control panel 7 of the self-propelled construction machine. The DGNSS rover unit 14 can also be assigned a different display that is not located at the operator station 6, but for example on one side of the machine frame 2, in order to be easily accessible to the operating personnel. The computing and evaluation unit 18 of the DGNSS rover unit 14 is configured such that all QR codes are shown on the display.

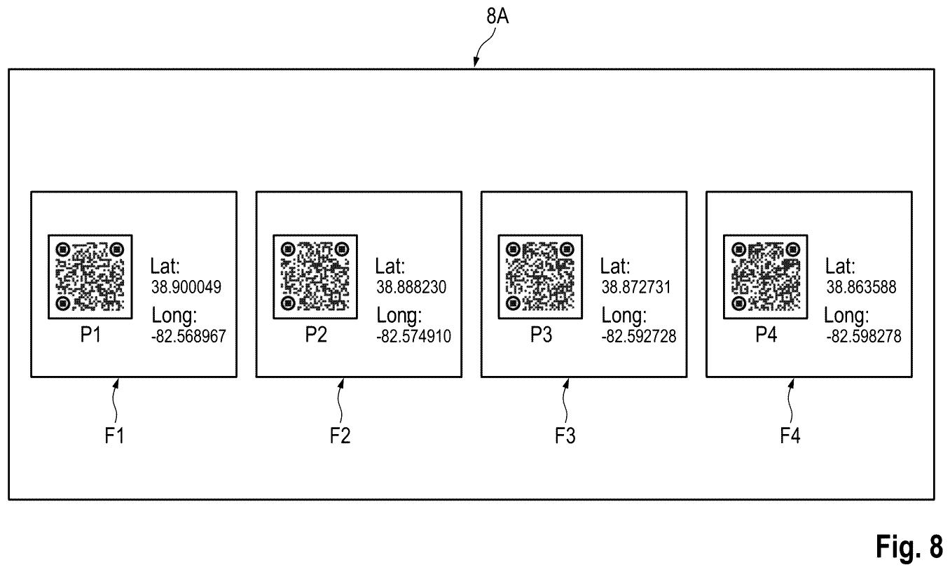

FIG. 8 shows the screen view of the display (8A) provided on the self-propelled construction machine. The display (8A) shows four fields F1, F2, F3, and F4, wherein each field is assigned a reference station setup point P1, P2, P3, and P4. In the fields F1, F2, F3, and F4, the geographical coordinates of the respective reference station setup points P1, P2, P3, and P4 (latitude (φ) and longitude (Δ)) are indicated in decimal form. In addition to the geographical coordinates, the corresponding QR code containing the geographical coordinates is shown.

The computing and evaluation unit 18 of the DGNSS rover unit 14 is configured such that in each case, i.e. for each data sub-set of the reference station position data set, a QR code containing the URL of a website is generated for the reference station setup points P1, P2, P3, and P4. This is illustrated below with reference to the first reference station setup point P1.

In the first field F1, the geographical coordinates for the first reference station setup point P1 are displayed as follows:
Lat: 38.900049 (Latitude (φ))
Long: −82.568967 (Longitude (Δ))

The above information can also be specified in a sexagesimal format as follows:
38°54′00.2″N 82°34′08.3″W

Consequently, the position data are made available to the operating personnel in a readable form.

The following information is decoded in the QR code of the first field F1:
Google.de/maps/?q=38.900049,−82.568967

The above information is the string of characters that must be entered into a browser to access a website (URL). Consequently, the operating personnel can easily locate the first reference station setup point P1 using a mobile terminal 26, in particular a smartphone on which an online map service with a navigation function, e.g., Google Maps of the company Google LLC, is installed. For accessing this map service, the operating personnel reads the first QR code using the smartphone 26. For this purpose, the operating personnel can use the camera function of the smartphone, which generally also allows the reading of a QR code. After reading the QR code, a map provided by the map service opens, showing the position of the reference station setup point P1 in, for example, a satellite image. In the present exemplary embodiment, the map service also contains a navigation function. The operating personnel can thus use the navigation function in order to reach the reference station setup point of the first reference station.

In this connection, the initialization of the reference station required after setting up the reference station 15 is described below, which, in the present exemplary embodiment, can be carried out by the reference station itself.

The computing and evaluation unit 18 of the DGNSS rover unit 14 and the computing and evaluation unit 21 of the reference station 15 are configured such that the following method steps are carried out to initialize the reference station.

The reference station 15 set up at a reference station setup point P1, P2, P3, or P4 receives the satellite signals S and transmits the measured position data via the transmitting and receiving unit 22 to the DGNSS rover unit 14, which data describe the reference station position determined by the reference station (FIG. 3, FIGS. 4 to 7). These position data are received by the DGNSS rover unit 14 via the transmitting and receiving unit 19. On the basis of a comparison of the position data of the reference station contained in the reference station data set with the reference station position determined by the reference station 15, the DGNSS rover unit 14 determines the actual reference station position and sends the position data describing the actual reference station position via the transmitting and receiving unit 19 to the reference station 15, which receives these position data via the transmitting and receiving unit 22. Once the reference station 15 knows its actual position, its computing and evaluation unit 22 calculates the correction signals, which it transmits to the DGNSS rover unit 14. The computing and evaluation unit 18 of the DGNSS rover unit 14 then calculates, on the basis of the satellite signals and the correction signals, the construction machine position data describing the exact position of the reference point R on the construction machine.

The comparison for selecting the associated position data is described in detail in DE 10 2022 124 484 A1 (US 2024/103179) which is incorporated herein by reference.

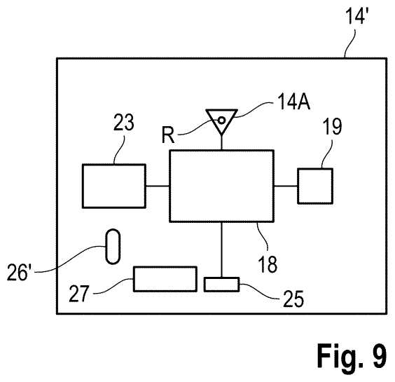

FIG. 9 shows an alternative embodiment of the DGNSS rover unit 14′, which differs from the DGNSS rover unit 14 shown in FIG. 3 in that the DGNSS rover unit 14′ has an NFC transmitting unit 27 based upon RFID technology. In FIG. 9, the same reference signs are used for corresponding parts. In the alternative embodiment, the mobile terminal 26′ is an NFC receiving unit (NFC reader) based upon RFID technology. In the alternative embodiment, the transmission of the machine-readable data set can be carried out by bringing the mobile terminal 26′ into the vicinity of the NFC transmitting unit 27′. An NFC receiving unit can be part of a smartphone, so that, even in the alternative embodiment, a smartphone can be used to read out the data, and other functions of the smartphone can be used for further data processing.

1-15. (canceled)

16. A self-propelled construction machine, comprising:
a machine frame;
a plurality of wheels or tracks supporting the machine frame from a ground surface;
a working tool supported from the machine frame and configured to work the ground surface or erect structures on the ground surface; and
a DGNSS rover unit associated with the self-propelled construction machine, the DGNSS rover unit being configured to receive satellite signals of a global navigation satellite system and correction signals of a reference station to be set up in a vicinity of the construction machine, the DGNSS rover unit including a computing and evaluation unit configured such that on a basis of the satellite signals and the correction signals, construction machine position data describing a position of a construction machine reference point on the construction machine are determined in a coordinate system independent of the construction machine;
wherein the computing and evaluation unit includes a reference station position data memory configured to store a reference station position data set including a plurality of data sub-sets of reference station position data, wherein each of the data sub-sets describes a location of one of a plurality of reference station setup points in a vicinity of a path along which the construction machine moves; and
wherein the computing and evaluation unit is configured such that one or more machine-readable data sets are generated corresponding to the reference station position data set.

17. The self-propelled construction machine of claim 16, wherein:
each machine-readable data set includes at least one machine-readable code; and
the DGNSS rover unit further includes a display configured such that the at least one machine-readable code is shown on the display.

18. The self-propelled construction machine of claim 17, wherein:
the machine-readable code is a QR code.

19. The self-propelled construction machine of claim 17, wherein:
the computing and evaluation unit is configured such that for each data sub-set at least one of the machine-readable codes containing the reference station position data of the respective reference station setup point corresponding to the data sub-set is generated and stored in the reference station position data memory.

20. The self-propelled construction machine of claim 19, wherein:
the computing and evaluation unit is configured such that the machine-readable codes of all the data sub-sets of reference station position data are shown on the display.

21. The self-propelled construction machine of claim 16, wherein:
the DGNSS rover unit further includes a transmitting unit configured such that at least one of the machine-readable data sets is transmitted to a mobile terminal by the transmitting unit.

22. The self-propelled construction machine of claim 16, wherein:
the computing and evaluation unit is configured such that at least one of the machine-readable data sets includes a URL of a website.

23. The self-propelled construction machine of claim 16, wherein:
the reference station position data memory includes an interface configured to import the reference station position data from an external data source.

24. The self-propelled construction machine of claim 16, further comprising:
a mobile terminal on which an online map service is available.

25. The self-propelled construction machine of claim 24, wherein:
the mobile terminal is a smartphone.

26. The self-propelled construction machine of claim 24, wherein:
the mobile terminal is configured such that the online map service is activated by scanning a QR code.

27. The self-propelled construction machine of claim 26, wherein:
the mobile terminal is configured such that the online map service includes a navigation function.

28. A method of locating a reference station setup point of a reference station to be set up in a vicinity of a self-propelled construction machine, the self-propelled construction machine including a machine frame, a plurality of wheels or tracks supporting the machine frame from a ground surface, a working tool supported from the machine frame and configured to work the ground surface or erect structures on the ground surface, and a DGNSS rover unit associated with the self-propelled construction machine, the DGNSS rover unit being configured to receive satellite signals of a global navigation satellite system and correction signals of a reference station to be set up in a vicinity of the construction machine, the DGNSS rover unit including a computing and evaluation unit configured such that on a basis of the satellite signals and the correction signals, construction machine position data describing a position of a construction machine reference point on the construction machine are determined in a coordinate system independent of the construction machine, the method comprising:
importing a reference station position data set from an external data source into a reference station position data memory, wherein the reference station position data set describes locations of a plurality of reference station setup points in a vicinity of a path along which the self-propelled construction machine is to move; and
creating one or more machine-readable data sets corresponding to the reference station position data set and storing the machine-readable data sets in the reference station position data memory with the computing and evaluation unit.

29. The method of claim 28, wherein:
the one or more machine-readable data sets are one or more machine-readable codes;
the method further includes:
displaying the one or more machine-readable codes on a display of the DGNSS rover unit; and
scanning the one or more machine-readable codes with a mobile terminal.

30. The method of claim 29, wherein:
the mobile terminal is a smartphone.

31. The method of claim 28, further comprising:
transmitting the one or more machine-readable data sets to a mobile terminal.

32. The method of claim 28, further comprising:
transmitting the one or more machine-readable data sets to a mobile terminal using a transmitter based on RFID technology.

33. The method of claim 28, further comprising:
locating one or more of the reference station setup points on a worksite using an online map service on a mobile terminal.

34. The method of claim 28, further comprising:
locating one or more of the reference station setup points on a worksite using a navigation function of an online map service on a mobile terminal.

35. The method of claim 28, wherein:
the one or more machine-readable data sets are one or more machine-readable codes including a URL of a website.
